(19) United States
(12) Patent Application Publication
(10) Pub. No.: US 2012/0036348 A1
(43) Pub. Date: Feb. 9, 2012

(54) DECRYPTION AND PRINT FLOW CONTROL SYSTEM AND METHOD

(75) Inventors: Gilbert A. Grodsky, Burbank, CA (US); Richard T. Horn, Claremont, CA (US)

(73) Assignee: Xerox Corporation

(21) Appl. No.: 12/852,294

(22) Filed: Aug. 6, 2010

(51) Int. Cl. H04L 9/00

(52) U.S. Cl. 713/150

(57) ABSTRACT

A method and system for determining a data file's security classification, special handling instructions, and disposition, with the additional option of subsequently adding material to the print image contained within the document, is disclosed. The method and system provide control of sensitive information contained in print documents, wherein a first file is encrypted. A second document accompanies the first document containing information for decrypting the first document, control redaction, and/or provide for addition of content or restrictions as to which rendering device the first document may print on. The rendering device, upon receipt of both first and second documents, communicates with a host computer that determines the first document's classification and disposition. The host computer then processes the second document, sending decryption information over a secure line from the second document to the rendering device to enable decryption and modification of the first document, followed by rendering.

### TECHNICAL FIELD

Embodiments relate to rendering devices, techniques and image-processing methods and systems. Embodiments further relate to secure print documents, encryption, and decryption. Embodiments additionally relate to adding material to secure documents containing encrypted information.

### BACKGROUND OF THE INVENTION

Secure printing architectures are commonly requested by various entities, such as banks, insurance companies and government groups, when sending print files over significant distances or through low security environments. Un-approved release of classified, high value, or otherwise sensitive documents can be a serious problem. Various techniques may exist to track individual pages and/or content on individual pages of these secure documents. To help satisfy these security needs, entire specialized print systems are usually dedicated to one kind of print traffic, such as, for example classified, unclassified, or even customer specific confidential documents. The security of sensitive information can be compromised in conventional networked printing environments, even with a specialized printing system. Software can be installed to intercept print jobs as the job is routed to a printer within a network. It is costly to acquire special purpose printers and retrofit new equipment within an established network to address security issues. Control of the entire highly sensitive document during printing, in a cost-effective manner, is an ongoing concern of the printing industry that needs to be addressed.

One method of securing documents is encryption. Secure documents can be encrypted to prevent unauthorized access to the information contained within that document. Access to this information requires a key to decrypt information contained within an encrypted document. Various key exchange methodologies exist to securely transfer a key to the receiver. The key's receiver must have a method to securely receive, store, or transport the key. Even with the encryption methods used to secure documents, it is often difficult to completely eliminate the possibility that the information is unsecured or subject to tampering.

Therefore a need exists for a cost-effective, universal method of securing documents and determining document classification and disposition, with the additional option of subsequently adding and/or removing information on the print image, while maintaining a centralized record of each action.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for improved rendering devices, techniques and image-processing methods and systems.

It is another aspect of the present invention to provide for improved secure print documents, encryption, and decryption.

It is a further aspect of the present invention to provide for adding material to the print image of a secure document, including overt and/or covert control markings for offline tracking.

A method and system for determining a data file's security classification, special handling instructions, and disposition, with the additional option of subsequently adding material to the print image contained within the document, is disclosed. The method and system provide control of sensitive information contained in print documents, wherein a first, actual print document file (PDF, PS, txt, etc.) is encrypted. A second document accompanies the first document containing information for decrypting the first document, control redaction, and/or provide for addition of content or restrictions as to which rendering device the first document may print on. Both the first and second documents can be sent simultaneously or consecutively to a printer. The rendering device, upon receipt of both first and second documents, communicates with a host computer. The host computer determines the first document's classification and disposition, and supports the real time acquisition of information from the print image for possible post processing. A secure document can be modified prior to raster image processing (RIPing) and its processing/finishing controls can change post RIPing. The host computer then processes the second document, sending decryption information over a secure line from the second document to the rendering device to enable decryption and modification of the first document, followed by rendering.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a sample data-processing apparatus, which can be utilized for processing secure data, in accordance with the disclosed embodiments;

FIG. 2 illustrates a schematic view of a software system including an operating system, application software, and a user interface for carrying out the disclosed embodiments;

FIG. 3 illustrates an exemplary graphical user interface (GUI) for display of relevant rendering option selections and data file modification options, in accordance with the disclosed embodiments;

FIG. 4 illustrates a flow chart of operations depicting logical operational steps of a method for processing and rendering secure data, in accordance with the disclosed embodiments; and

FIG. 5 illustrates a flow chart of operations depicting logical operational steps of a method for processing and rendering secure data using a rendering control option, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

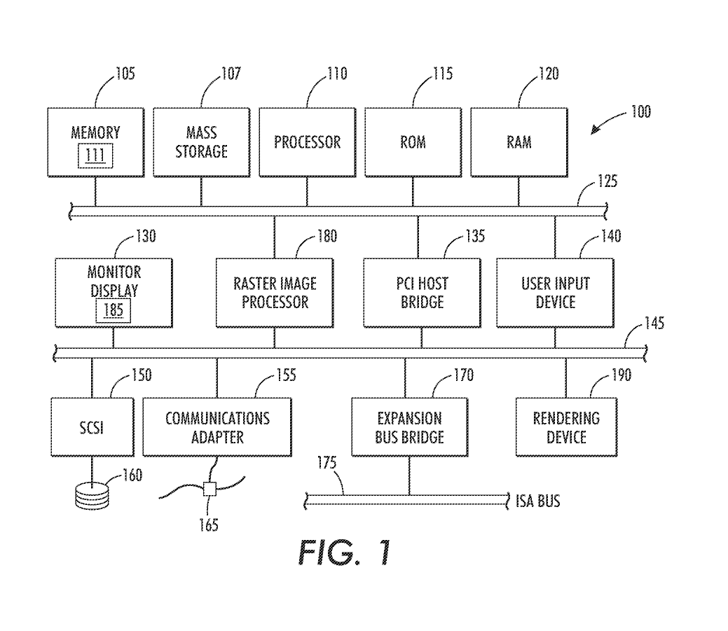

FIG. 1 illustrates a block diagram of a sample data-processing apparatus 100, which can be utilized for processing secure data and provide rendering option selections and data file modification options. Data-processing apparatus 100 represents one of many possible data-processing and/or computing devices, which can be utilized in accordance with the disclosed embodiments. It can be appreciated that data-processing apparatus 100 and its components are presented for generally illustrative purposes only and do not constitute limiting features of the disclosed embodiments.

As depicted in FIG. 1, a memory 105, a mass storage 107 (e.g., hard disk), a processor (CPU) 110, a Read-Only Memory (ROM) 115, and a Random-Access Memory (RAM) 120 are generally connected to a system bus 125 of data-processing apparatus 100. Memory 105 can be implemented as a ROM, RAM, a combination thereof, or simply a general memory unit. Module 111 includes software module in the form of routines and/or subroutines for carrying out features of the present invention and can be additionally stored within memory 105 and then retrieved and processed via processor 110 to perform a particular task. A user input device 140, such as a keyboard, mouse, or another pointing device, can be connected to PCI (Peripheral Component Interconnect) bus 145. Module 111 can be adapted for providing a graphical user interface 300 for providing rendering option selections and data file modification options. Processor 110 can be adapted to process secure data files and send to a rendering device when decrypted and/or modified.

Data-process apparatus 100 can thus include CPU 110, ROM 115, RAM 120, and a rendering device 190 (e.g., printer, copier, scanner, xerography equipment etc.), which are also coupled to a PCI (Peripheral Component Interconnect) local bus 145 of data-processing apparatus 100 through PCI Host Bridge 135. The PCI Host Bridge 135 can provide a low latency path through which processor 110 may directly access PCI devices mapped anywhere within bus memory and/or input/output (I/O) address spaces. PCI Host Bridge 135 can also provide a high bandwidth path for allowing PCI devices to directly access RAM 120.

A communications adapter 155, a small computer system interface (SCSI) 150, a raster image processor (RIP) 180, and an expansion bus-bridge 170 can also be attached to PCI local bus 145. The communications adapter 155 can be utilized for connecting data-processing apparatus 100 to a network 165. SCSI 150 can be utilized to control high-speed SCSI disk drive 160. An expansion bus-bridge 170, such as a PCI-to-ISA bus bridge, may be utilized for coupling ISA bus 175 to PCI local bus 145. Note that PCI local bus 145 can further be connected to a monitor 130, which functions as a display (e.g., a video monitor) for displaying data and information for a user and also for interactively displaying a graphical user interface (GUI) 300.

The embodiments described herein can be implemented in the context of a host operating system and one or more modules. Such modules may constitute hardware modules, such as, for example, electronic components of a computer system. Such modules may also constitute software modules. In the computer programming arts, a software “module” can be typically implemented as a collection of routines and data structures that performs particular tasks or implements a particular abstract data type.

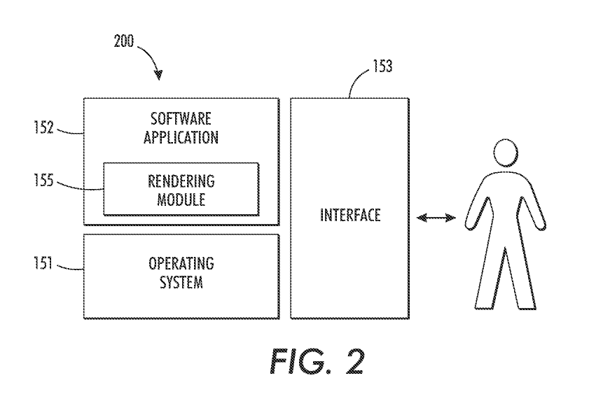

Software modules generally can include instruction media storable within a memory location of an image processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented through signal-bearing media, including transmission media and/or recordable media. An example of such a module that can embody features of the present invention is rendering module 155, depicted in FIG. 2.

It is important to note that, although the embodiments are described in the context of a fully functional data-processing system (e.g., a computer system), those skilled in the art will appreciate that the mechanisms of the embodiments are capable of being distributed as a program product in a variety of forms, and that the present invention applies equally regardless of the particular type of signal-bearing media utilized to actually carry out the distribution. Examples of signal bearing media include, but are not limited to, recordable-type media such as media storage or CD-ROMs and transmission-type media such as analogue or digital communications links.

FIG. 2 illustrates a schematic view of a software system 200 including an operating system, application software, and a user interface for carrying out the disclosed embodiments. Computer software system 200 directs the operation of the data-processing system 100 depicted in FIG. 1. Software application 152, stored in main memory 105 and on mass storage 107, includes a kernel or operating system 151 and a shell or interface 153. One or more application programs, such as software application 152, may be “loaded” (i.e., transferred from mass storage 107 into the main memory 102) for execution by the data-processing system 100. The data-processing system 100 receives user commands and data through the interface 153, as shown in FIG. 2. The user's command input may then be acted upon by the data-processing system 100 in accordance with instructions from operating module 151 and/or application module 152.

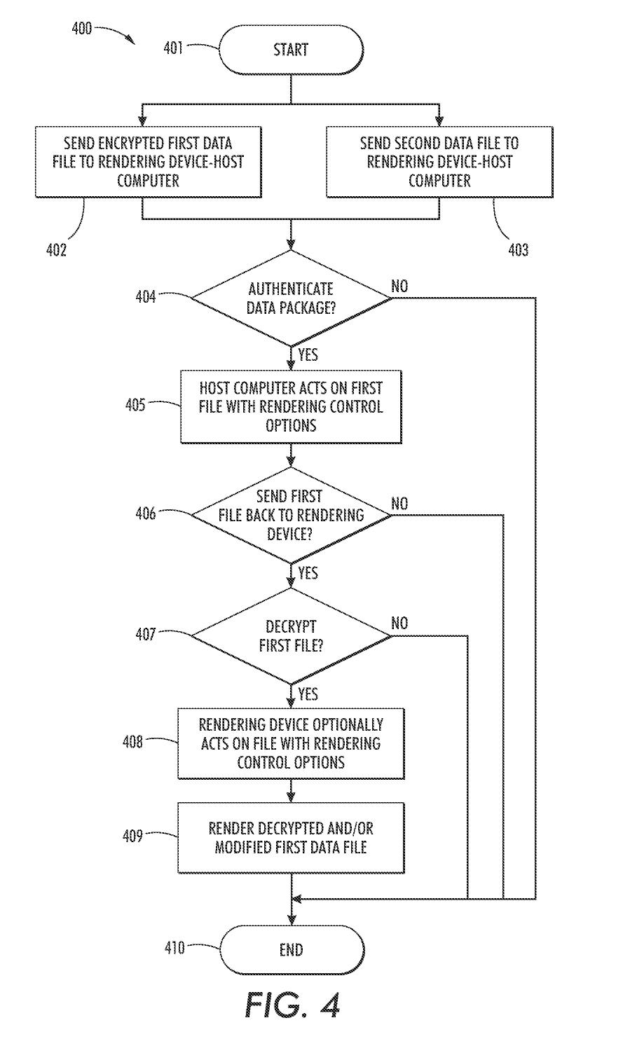

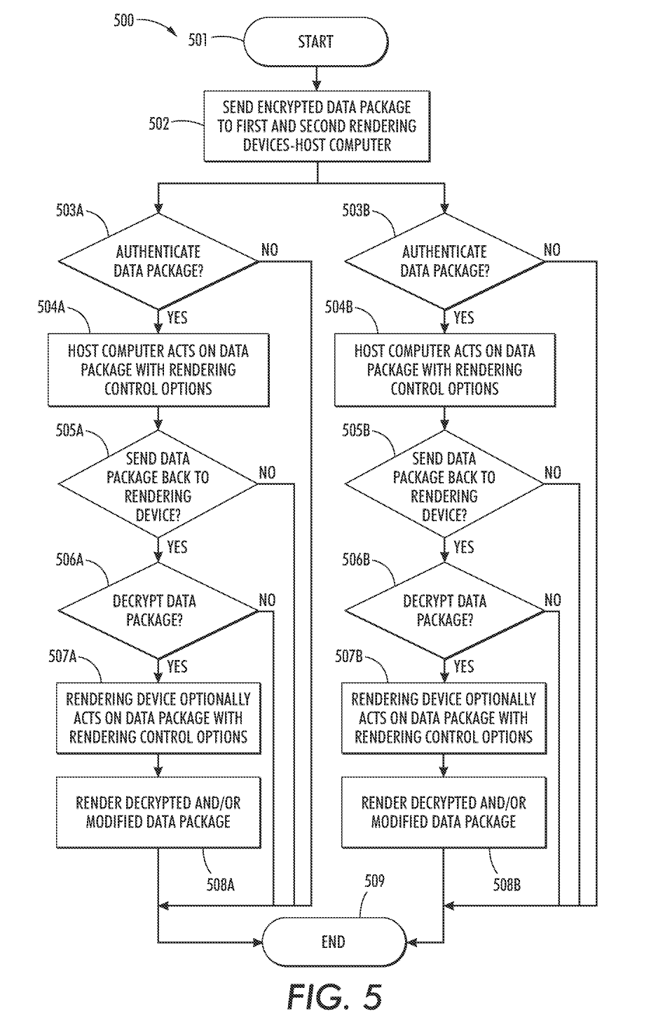

The interface 153 also serves to display printer and/or host computer print job modification results, whereupon the user may supply additional inputs or terminate the session. In an embodiment, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 153. The software application 152 can include a rendering module 155 that can be adapted to control secure documents with respect to rendering, document modifications, encryption, and decryption, as described in greater detail herein. The software application 152 can also be configured to communicate with the interface 153 and various components and other modules and features as described herein. The rendering module 155, in particular, can implement instructions for carrying out, for example, the methods 400 and 500 depicted in FIGS. 4 and 5, respectively, as described below, and/or additional operations as described herein.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program design to assist in the performance of a specific task, such as word processing, accounting, inventory management, music program scheduling, etc.

Generally, program modules include routines, programs, objects, components, data structures, etc., that perform particular tasks or implement particular abstract data types. Moreover, those skilled in the art will appreciate that the disclosed method and system may be practiced with other computer system configurations, such as, for example, hand-held devices, multi-processor systems, microprocessor-based or programmable consumer electronics, networked PCs, minicomputers, mainframe computers, and the like.

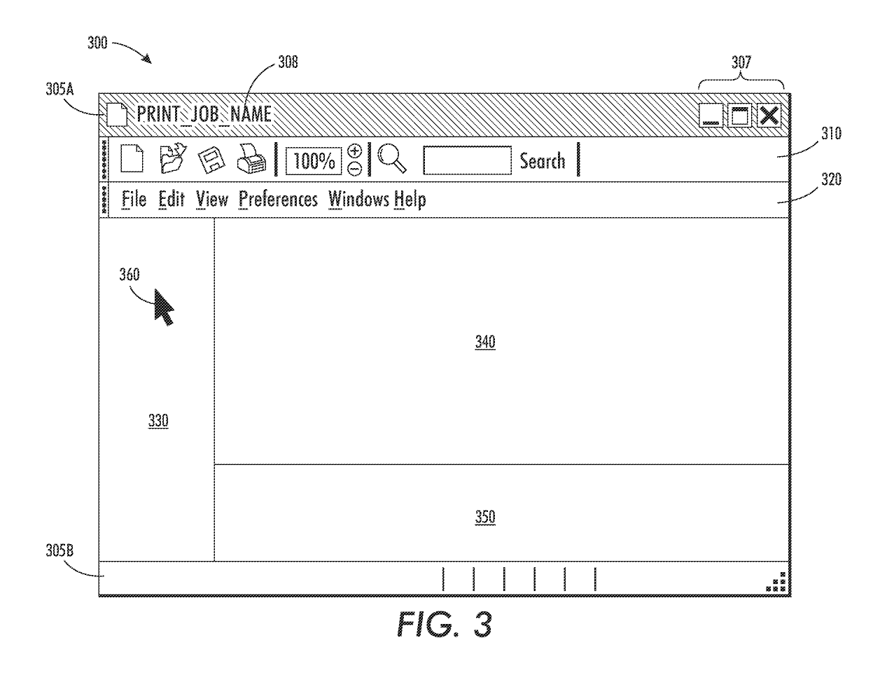

FIG. 3 illustrates an exemplary graphical user interface (GUI) 300 for display of relevant rendering option selections and data file modification options, in accordance with the disclosed embodiments. Note that the term “GUI” generally refers to a type of environment that represents programs, files, options and so forth by means of graphically displayed icons, menus, and dialog boxes on a computer monitor screen. A user actuates the appropriate keys on the user interface 185 to select rendering and data file modification options. A user can access and operate the rendering device 190 using the GUI 300. The reasoning system can be a software module such as, for example, the module 155 of depicted in FIG. 2.

The rendering software module 155, as disclosed herein, is configured to generate a GUI 300 on a display device. For example, the display device may include a cathode ray tube, liquid crystal display, plasma, or other display device. The GUI 300 may provide one or more windows or panes for displaying information to the user. The GUI 300 may be a window-like presentation defined by a top border 305A and bottom border 305B. Typical windows-like controls 207, included minimize, maximize and close functions, may be provided at the upper-right hand corner (or at other locations) of the top border 305. The name of the print job 308 may be displayed at the top of the GUI 300, for example, in the top border 205A. A menu bar 310 and tool bar 320 may be provided just below the top border 305A (or at other locations). The menu bar 310 may include a number of option menus, for example, File options, Edit options, View options, Preferences options, and Window options, and Help options, etc. The tool bar 310 may include a number of features and options, such as shortcut features to create a new file, open a file, save a file, print a file, a zoom feature, a magnification feature, and a search feature. Many of the features and options of the menu bar 310 and/or tool bar 320 may be conventional and/or customizable to support aspects of the application 100.

A user can interact with the GUI 300 to select and activate such options by pointing and clicking with a user input device such as, for example, a pointing device such as a mouse, and/or a keyboard. The GUI 300 controls the various display and input/output features of the application and allows a user to interact with the application 100 via a computer's operating system and/or one of more software applications. A pointer 360 may be provided to facilitate user interaction. For example, the user may use a mouse, joystick, light pen, roller-ball, keyboard, or other peripheral devices for manipulating the pointer 360 over the GUI 300. Further, the pointer 360 may permit the user to navigate between the menu bar 310, the tool bar 320, and each of the panes 330, 340, 350 of the GUI 300, as well as to select features and options from among various menus, “pop-up” windows, icons, prompts, etc.

The GUI 300 may include one or more active windows or panes. In one implementation, three primary panes may be provided, including a printer option selection display pane 330, a data file modification display pane 340, and a final print job display pane 350. These will be discussed in more detail below. Other windows and panes may similarly be provided. Various mechanisms for minimizing, maximizing, moving, and/or changing the dimensions or the individual panes, may be provided as typically found in a windows environment.

In some implementations, the pointer 360 may display location-specific and/or context-specific action menus, in response, for example, to the user hovering or right clicking on a certain pane or location of the GUI 300. The pointer 360 may be, for example, an icon or other indicia, such as an “arrow”. In some implementations, the user may be permitted to change the pointer 360 icon, for example, through the Preferences menu of the menu bar 310. As will be appreciated, the pointer 360 may readily permit other functionality. The pointer 360 may be configured to execute operations, for example, when the user right- or left-clicks a mouse. In some implementations, when the user moves the pointer icon 260 to a different pane or location within the GUI 300, its design and/or functionality may change.

FIG. 4 illustrates a flow chart of operations depicting logical operational steps of a method 400 for processing and printing secure data, in accordance with the disclosed embodiments. The method 400 can be implemented in the context of almost any workflow situation. It is best described in the following description in the context of a rendering, or printing environment. It can be appreciated that the printing environment context and its components are presented for generally illustrative purposes only and do not constitute limiting features of the disclosed embodiments. Benefits of the disclosed method 400 include the data file's processing steps being performed before the document is actually raster image processed (RIPed) to a print image. A print image has a decreased chance of being compromised with earlier print job processing. Further, the data file's print job stream is protected until authentication and decryption at a printer. With the disclosed method 400, there is complete, centralized control over when a print job is printed, and what printer is used, on a document-by-document basis. In addition, each document could be individualized in obvious and/or subtle ways.

A method and system for determining a data file's security classification, special handling instructions, and disposition, with the additional option of subsequently adding material to the print image contained within the document, is disclosed. The method and system provide control of sensitive information contained in print documents, wherein a first, actual print document file (PDF, PS, txt, etc.) is encrypted. A second document accompanies the first document containing information for decrypting the first document, control redaction, and/or provide for addition of content or restrictions as to which printing device the first document may print on. Both the first and second documents can be sent simultaneously or consecutively to a printer. The rendering device, upon receipt of both first and second documents, communicates with a host computer. The host computer determines the first document's classification and disposition, and supports the real time acquisition of information from the print image for possible post processing. A secure document can be modified prior to raster image processing (RIPing) and its processing/finishing controls can change post RIPing. The host computer then processes the second document, sending decryption information over a secure line from the second document to the rendering device to enable decryption and modification of the first document, followed by rendering.

As illustrated in block 401, the process for controlling and processing sensitive information contained in print documents can be initiated. Next, as illustrated in block 402, a first data file is transmitted to a printer for rendering. This first data file can be an encoded and/or encrypted file. The first data file can eventually become a PDF (or PS or txt, etc.) file when interpreted with the printer's software modules. The printer communicates with a host computer, either locally attached or connected remotely over the Internet, for print job processing and decryption instructions.

As illustrated in block 403, a second data file is transmitted to the same printer that communicates with the host computer. The second data file can be an associated, un-encrypted and/or un-encoded data file, which is sent, either simultaneously or consecutively with the first file, to the same printer that communicates with the host computer. As a companion file, the second data file contains identifications and instructions for the printer's controller, and optionally for the host computer's central database controller. The identifications and instructions provide for the first document's decryption path and further processing instructions, such as removing or adding data to each print image, and/or redirecting the first document to other printing destinations. The first and second data files, sent to the printer that communicates with the host computer, are collectively known as the “data package”.

As illustrated in block 404, software modules within the printer authenticate the data package. The authentication process can also involve controlling whether the printer has the correct, current authorizations and/or certifications to process the data package. If the data package cannot be authenticated, then the printing process ends, as illustrated in block 410.

Next, as illustrated in block 405, the host computer acts on the data package sent to the printer that communicates with the host computer, using any combination of rendering, or printer, control options. Exemplary rendering control options include, but are not limited to, the following: adding information into a rendering stream before rendering; removing information from a rendering stream before rendering; adding covert information; adding overt information; adding a centrally generated serial number; adding identification information; adding rendering device identification information; adding rendering device operator identification information; adding date and/or time stamp information; incorporating copy protection information; incorporating security information; incorporating microprint, watermark, security designations or warning information; incorporating forensic information to detect security breaches, in conjunction with information gathered from said host computer's central database; and deciding whether to automatically apply a redaction for increased control and security as instructed by said host computer. The host computer also decides whether to maintain a central database on the host computer to track information on every copy rendered of these sensitive documents.

As illustrated in block 406, the host computer decides whether to send the document back to the rendering device for rendering with any additional material added in block 405. If allowed, the first data file is sent to the printer that communicates with the host computer for decryption and printing. If the host computer does not allow printing, should a security breach occur, for example, then the printing process ends, as indicated in block 410.

As illustrated in block 407, the printer will decrypt the data file using the decryption key information provided by the host computer. The printer controller does not have to retain decryption keys, but the controller can be setup as qualified to accept or reject certain decryption keys, based on security guidelines. If the host computer indicates the existence of a security or business rule breach to the printer, then the first data file remains encrypted and the printing process ends, as illustrated in block 410.

Next, as illustrated in block 408, the printer can optionally modify the first data file's print stream as instructed by the host computer that communicates with the printer. The printer-controlled modification options may involve adding and/or removing data, including a microprint, watermark, security designations and warning, in addition to any previous modifications by the host computer, as previously described in block 405. The printer may not need to modify any further. As illustrated in block 409, the printer that communicates with the host computer prints the decrypted and/or modified print file. The process then terminates at block 410.

While these processing options are focused on a military or government scenario, the disclosed embodiments could also be used in a commercial setting to implement, for example, central control of any business policy. FIG. 5 illustrates a flow chart of operations depicting logical operational steps of a method 500 for processing and rendering secure data using a printer control option, in accordance with the disclosed embodiments.

For example, an encrypted print job at an insurance company includes a print run of 100,000 checks, along with associated check stubs and accounting information (collectively known hereafter as the “data package”). As illustrated in block 501, the process for controlling and processing the data package can be initiated. Next, as illustrated in block 502, the data package is consecutively or simultaneously transmitted to a first and second rendering device, such as, for example, a printer for rendering. The data package transmitted to the first rendering device is herein known as the “first data package”. The data package transmitted to the second rendering device is known as the “second data package”. Both the first and second data packages initially contain the same information (e.g. checks, check stubs, and accounting information) when transmitted to each respective rendering device. It is understood, however, that the data package can contain any amount of data and/or number of files or documents, can be sent to any number of rendering devices, can utilize any number of rendering control options, and can render any number of rendering jobs. The use of two rendering devices and one rendering control option in this non-limiting example is for illustrative purposes only.

The first data package is sent to a first rendering device, such as, for example, a MICR (Magnetic Ink Character Recognition) production printer, with an authorized operator. The second data package is sent to a second rendering device, such as, for example, another printer and/or operator associated with accounting (hereafter known as the “accounting printer”). Instead of two separate files being sent to a single printer, as disclosed in FIG. 4, the same data package can also be sent to different printers for processing, in accordance with the disclosed embodiments. The printers can either be connected to the same host computer or different host computers.

As illustrated in block 503a, the MICR printer authenticates the first data package. As illustrated in block 503b, the accounting printer authenticates the second data package. The authentication process in both 503a and 503b can involve controlling whether the printer has the correct, current authorizations and/or certifications to process the first and second data packages, respectively. If the first and/or second data packages cannot be authenticated, then the printing process ends, as illustrated in block 509.

As illustrated in block 504a, the host computer connected to the MICR printer initiates a printer control option by redacting the internal accounting information, thus leaving the checks and check stubs for rendering in the first data package. As illustrated in block 504b, the host computer connected to the accounting printer initiates a printer control option by redacting the check printing information, thus leaving the check stubs and accounting information for rendering in the second data package.

As illustrated in block 505a, the host computer connected to the MICR printer decides whether to send the redacted first data package back to the MICR printer for rendering. If allowed, the redacted first data package is sent to the MICR printer for decryption and printing. If the host computer does not allow printing, should a security breach occur, for example, then the printing process ends, as indicated in block 509. As illustrated in block 505b, the host computer connected to the accounting printer decides whether to send the redacted second data package back to the accounting printer for rendering. If allowed, the redacted second data package is sent to the accounting printer for decryption and printing. If the host computer does not allow printing, should a security breach occur, for example, then the printing process ends, as indicated in block 509.

As illustrated in block 506a, the MICR printer will decrypt the redacted first data package using the decryption key information provided by the host computer. The printer controller does not have to retain decryption keys, but the controller can be setup as qualified to accept or reject certain decryption keys, based on security guidelines. If the host computer indicates the existence of a security or business rule breach to the MICR printer, then the redacted first data package remains encrypted and the printing process ends, as illustrated in block 509. As illustrated in block 506b, the accounting printer will decrypt the redacted second data package using the decryption key information provided by the host computer. The printer controller does not have to retain decryption keys, but the controller can be setup as qualified to accept or reject certain decryption keys, based on security guidelines. If the host computer indicates the existence of a security or business rule breach to the accounting printer, then the redacted second data package remains encrypted and the printing process ends, as illustrated in block 509.

As illustrated in block 507a, the MICR printer then has the option to further act on the redacted first data package with other rendering control options. As illustrated in block 507b, the accounting printer also has the option to further act on the redacted second data package with rendering control options.

As illustrated in block 508a, the MICR printer then prints the redacted first data package comprising checks and associated check stubs. As illustrated in block 508b, the accounting printer then prints the redacted second data package comprising check stubs and accounting information. Sending the entire data package to two separate printers to process and redact the data package as needed, ensures informational accuracy, along with needed security for sensitive information. The process ends, as illustrated in block 509.

It will be appreciated that variations of the above-disclosed and other features and functions, or alternatives thereof, may be desirably combined into many other different systems or applications. Furthermore, various presently unforeseen or unanticipated alternatives, modifications, variations or improvements therein may be subsequently made by those skilled in the art which are also intended to be encompassed by the following claims.

What is claimed is:

1. A method for determining a data file's security classification, special handling instructions, and disposition, said method comprising:
transmitting an encrypted first data file to a rendering device for rendering, wherein said rendering device is connected to a host computer, by executing a program instruction in a data processing apparatus;
transmitting a second data file containing information for decrypting said encrypted first data file to said rendering device, wherein said rendering device is connected to a host computer, by executing a program instruction in a data processing apparatus; and
rendering a decrypted version of said first data file on a rendering device, by executing a program instruction in a data processing apparatus.

2. The method of claim 1 further comprising modifying said encrypted first data file using a rendering control option prior to rendering said encrypted first data file, by executing a program instruction in a data processing apparatus.

3. The method of claim 2 further comprising said host computer modifying said encrypted first data file using a rendering control option, wherein said rendering control option comprises at least one of the following:
adding information into a rendering stream before rendering;
removing information from a rendering stream before rendering;
adding covert information;
adding overt information;
adding a centrally generated serial number;
adding identification information;
adding rendering device identification information;
adding rendering device operator identification information;
adding date or time stamp information;
incorporating copy protection information;
incorporating security information;
incorporating microprint, watermark, security designations or warning information;
incorporating forensic information to detect security breaches, in conjunction with information gathered from said host computer's central database; and
deciding whether to automatically apply a redaction for increased control and security as instructed by said host computer.

4. The method of claim 2 further comprising said rendering device modifying said encrypted first data file using a rendering control option, wherein said rendering control option comprises at least one of the following:
adding information into a rendering stream before rendering;
removing information from a rendering stream before rendering;
adding covert information;
adding overt information;
adding a centrally generated serial number;
adding identification information;
adding rendering device identification information;
adding rendering device operator identification information;
adding date or time stamp information;
incorporating copy protection information;
incorporating security information;
incorporating microprint, watermark, security designations or warning information;
incorporating forensic information to detect security breaches, in conjunction with information gathered from said host computer's central database; and
deciding whether to automatically apply a redaction for increased control and security as instructed by said host computer.

5. The method of claim 1 further comprising said host computer:
authenticating said encrypted first data file and said second data file; and
determining said encrypted first document's security classification, special handling instructions, and disposition, by executing a program instruction in a data processing apparatus.

6. The method of claim 1 further comprising:
modifying said encrypted first data file prior to raster image processing, by executing a program instruction in a data processing apparatus; or
modifying said encrypted first data file's processing or finishing controls after raster image processing, by executing a program instruction in a data processing apparatus.

7. The method of claim 1 further comprising wherein said instructions in said second data file provide for redirecting said encrypted first data file to other rendering device destinations, by executing a program instruction in a data processing apparatus.

8. The method of claim 1 further comprising transmitting said encrypted first data file and said second data file to said rendering device either simultaneously or consecutively, by executing a program instruction in a data processing apparatus.

9. The method of claim 1 further comprising maintaining a central database on said host computer to track information on every copy rendered of said encrypted first data file, by executing a program instruction in a data processing apparatus.

10. A system for determining a data file's security classification, special handling instructions, and disposition, said system comprising:
a processor;
a data bus coupled to said processor; and
a computer-usable medium embodying computer code, said computer-usable medium being coupled to said data bus, said computer program code comprising instructions executable by said processor and configured for:
transmitting an encrypted first data file to a rendering device for rendering, wherein said rendering device is connected to a host computer, by executing a program instruction in a data processing apparatus;
transmitting a second data file containing information for decrypting said encrypted first data file to said rendering device, wherein said rendering device is connected to a host computer, by executing a program instruction in a data processing apparatus; and
rendering a decrypted version of said first data file on a rendering device, by executing a program instruction in a data processing apparatus.

11. The system of claim 10 wherein said instructions executable by said processor are further configured to modify said encrypted first data file using a rendering control option prior to rendering said encrypted first data file, by executing a program instruction in a data processing apparatus.

12. The system of claim 11 wherein said instructions executable by said processor are further configured for said host computer to modify said encrypted first data file using a rendering control option, wherein said rendering control option comprises at least one of the following:
adding information into a rendering stream before rendering;
removing information from a rendering stream before rendering;
adding covert information;
adding overt information;
adding a centrally generated serial number;
adding identification information;
adding rendering device identification information;
adding rendering device operator identification information;
adding date or time stamp information;
incorporating copy protection information;
incorporating security information;
incorporating microprint, watermark, security designations or warning information;
incorporating forensic information to detect security breaches, in conjunction with information gathered from said host computer's central database; and
deciding whether to automatically apply a redaction for increased control and security as instructed by said host computer.

13. The system of claim 11 wherein said instructions executable by said processor are further configured for said rendering device to modify said encrypted first data file using a rendering control option, wherein said rendering control option comprises at least one of the following:
adding information into a rendering stream before rendering;
removing information from a rendering stream before rendering;
adding covert information;
adding overt information;
adding a centrally generated serial number;
adding identification information;
adding rendering device identification information;
adding rendering device operator identification information;
adding date or time stamp information;
incorporating copy protection information;
incorporating security information;
incorporating microprint, watermark, security designations or warning information;
incorporating forensic information to detect security breaches, in conjunction with information gathered from said host computer's central database; and
deciding whether to automatically apply a redaction for increased control and security as instructed by said host computer.

14. The system of claim 10 wherein said instructions executable by said processor are further configured for said host computer to:
authenticate said encrypted first data file and said second data file; and
determine said encrypted first document's security classification, special handling instructions, and disposition, by executing a program instruction in a data processing apparatus.

15. The system of claim 10 wherein said instructions executable by said processor are further configured to:
modify said encrypted first data file prior to raster image processing, by executing a program instruction in a data processing apparatus; or
modify said encrypted first data file's processing or finishing controls after raster image processing, by executing a program instruction in a data processing apparatus.

16. The system of claim 10 wherein said instructions executable by said processor are further configured for said instructions in said second data file to provide for redirecting said encrypted first data file to other rendering device destinations, by executing a program instruction in a data processing apparatus.

17. The system of claim 10 wherein said instructions executable by said processor are further configured to transmit said encrypted first data file and said second data file to said rendering device either simultaneously or consecutively, by executing a program instruction in a data processing apparatus.

18. The system of claim 10 wherein said instructions executable by said processor are further configured to maintain a central database on said host computer to track information on every copy rendered of said encrypted first data file, by executing a program instruction in a data processing apparatus.

19. A method for determining a data file's security classification, special handling instructions, and disposition, said method comprising:
transmitting an encrypted first data package to a first rendering device for rendering and transmitting an encrypted second data package to a second rendering device for rendering, wherein said first rendering device is connected to a host computer, and wherein said second rendering device is connected to a host computer, by executing a program instruction in a data processing apparatus;
modifying said encrypted first data package sent to a first rendering device using a rendering control option prior to rendering said encrypted first data package, by executing a program instruction in a data processing apparatus;
modifying said encrypted second data package sent to a second rendering device using a rendering control option prior to rendering said encrypted second data package, by executing a program instruction in a data processing apparatus;
decrypting said encrypted data package sent to a first rendering device prior to rendering said encrypted first data package, by executing a program instruction in a data processing apparatus;
decrypting said encrypted second data package sent to a second rendering device prior to rendering said encrypted second data package, by executing a program instruction in a data processing apparatus;
rendering a decrypted and modified version of said encrypted first data package sent to a first rendering device, by executing a program instruction in a data processing apparatus; and
rendering a decrypted and modified version of said encrypted second data package sent to a second rendering device, by executing a program instruction in a data processing apparatus.

20. The method of claim 19 further comprising said host computer connected to either first or second rendering device modifying said first and second data packages using a rendering control option, wherein said rendering control option comprises at least one of the following:
adding information into a rendering stream before rendering;
removing information from a rendering stream before rendering;
adding covert information;
adding overt information;
adding a centrally generated serial number;
adding identification information;
adding rendering device identification information;
adding rendering device operator identification information;
adding date or time stamp information;
incorporating copy protection information;
incorporating security information;
incorporating microprint, watermark, security designations or warning information;
incorporating forensic information to detect security breaches, in conjunction with information gathered from said host computer's central database; and
deciding whether to automatically apply a redaction for increased control and security as instructed by said host computer.
